(19) United States
(12) Patent Application Publication
(10) Pub. No.: US 2021/0167625 A1
(43) Pub. Date: Jun. 3, 2021

(54) CHARGER DEVICE TO GENERATE ELECTRICITY THROUGH ELECTROMAGNETIC INDICATION TRANSFORMATION

(71) Applicant: Waleed AL HAMAD, Riyadh (SA)

(72) Inventor: Waleed AL HAMAD, Riyadh (SA)

(21) Appl. No.: 17/258,975

(22) PCT Filed: Jun. 30, 2019
(86) PCT No.: PCT/SA2019/000006

§ 371 Date: Jan. 8, 2021

(30) Foreign Application Priority Data
Jul. 8, 2018 (SA) 118390708

(51) Int. Cl. H02J 7/04; H02J 50/20; H02J 50/40; H02J 50/10; H02J 50/00; H02J 7/34

(52) U.S. Cl. CPC H02J 7/04; H02J 50/20; H02J 50/40; H02J 2207/50; H02J 50/001; H02J 7/345; H02J 50/10

(57) ABSTRACT

The invention relates to a device which has to work for producing electricity power by converting the electromagnetic induction of the radio frequencies in the atmosphere into the electric energy that can be used by using an electronic circuit that collects the electrical energy resulting from the induction and then storing this energy GPS, 2G/3G/4G (Ie, smart phones, electronic devices, and all devices) that need in general energy (see FIG. 1).

### FULL DESCRIPTION

### Invention Background

By the process to find a device for getting a safe, alternative and easy-to-use power, there is no device yet to provide: mobile phones, electronic devices, electrical appliances, electric cars, airplanes, road lighting lamps and all devices that need energy in a self-sufficient manner and do not need an external source to obtain energy and be at the same time safe. The researchers have at most able to send power through wireless (but still needs an external power source that shall be very near in a distance. They are able in most to send power through the wireless transmission station which will broadcast in the area not to exceed seventy feet) 21 meters).

I have reached after this invention to invent a charger for electric power generation by converting electromagnetic induction into electrical energy.

There is a former patent registered with the Saudi Patent Office under registration (No. 5914), which is designed to convert the electromagnetic induction of radio waves in the air into electrical energy. Such device is used as a source of self-energy to supply all electronic devices, lighting, electrical appliances, mobile devices, Electric-powered vehicles, airplanes electric navigation devices which used 15 voltage as an alternative to provide the supply of electricity, power of buildings, and all uses of electric power in general, and generator).

### GENERAL DESCRIPTION

### The Problem

The old experiments did not show an integrated device that converts the electromagnetic induction to 20 electrical energy, which is used effectively to solve the problem of charging smart phones, electronic devices and cars electric operated and any device in need of electric source but it is commonly fixed source in a distance not far more than few meters. In addition, electric power infrastructure to obtain electricity is expensive and need the effort and time for laying extensions, cables and electrical wires, and is relatively lacking the security component.

### Overcome the Problem

In this invention, a copper capillary tubular antenna has been developed to improve the performance of the receiving antenna of the device and to be the nearest SIM CARD connection point to the frequencies. It will be also a connection point where the power resulted from the towers of communication process is collected and to control remotely the device and maintaining the license rights of the users. As the previous techniques did not helping to generate continuously energy upon getting such rights. The required voltage is not yet reached, and the difficulty is that a device needs energy that to be provided from an external source. This invention does not need such external source of power and no connections or cables are needed. This device is portable so that it can be carried anywhere with us and is made in different sizes according to the needs of each device: mobile phone, electronic devices, electrical appliances, airplanes , road lightings and all devices that need a power source and do not need an external power source.

### A BRIEF EXPLANATION OF DIAGRAMS

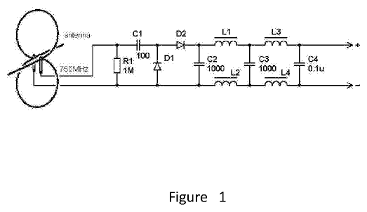

FIG. 1: Device internal components diagrams.

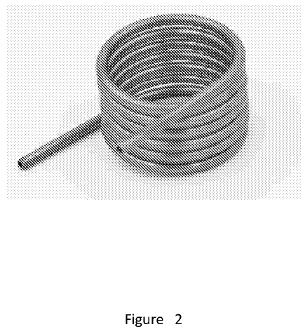

FIG. 2: polarization unit.

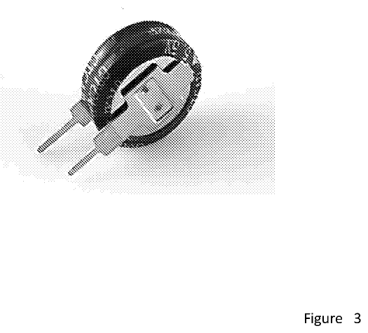

FIG. 3: Capacitors of the storage unit.

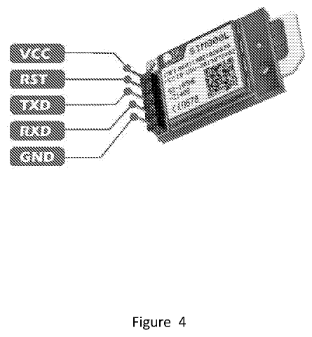

FIG. 4: Communication Unit.

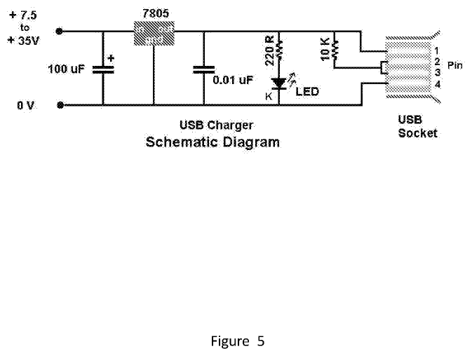

FIG. 5: Components of the charging circuit.

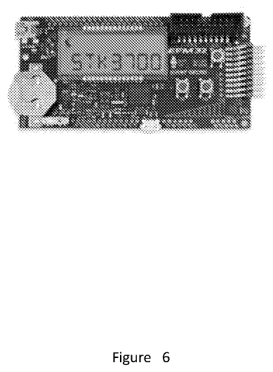

FIG. 6: Microcontroller.

### DETAILED DESCRIPTION

The device consists of three electronic units for the process of polarization of electricity and then stored and from and then giving an output as a suitable power to charge the devices as in FIG. 1.

### Polarization Unit

It is a copper capillary tubular two-pin signal receiving antenna with a 31.2-mm in length (5 cm as shown in FIG. 2) to unify the current direction to be the Choke Diode connected to the ends of the diode and then connect the two ends of the diodes with a large DC capacitors in the form of continuous current (1000 capacity microfa and 5.5 V as in FIG. 3) Supercapacitor

### Communication Unit

It is an electronic circuit that contains a connection segment and acts as a communication point with the mobile telephones towers. Its main function is to maintain continuous communication with the towers to form an aura of electromagnetic frequencies so that the energy generated by the connection is assembled. This unit is available in the market because it does not need a large amount of power to operate on the SIM800L with multiple models (FIG. 4)

### 15—Unit Charging

The charging unit is a circuit that finalizes the electrical current out of the storage capacitor to suit the needs of the charging device or its operation, and since standardization of charging standards must be done as a charging port or power supply, this helps to make the USP USB module is compatible with USB standard to be used as a charger or sufficient source for operating devices such as smart phones, electronic devices, electric vehicles and other devices that need energy.

1- Charger device to generate electricity through the conversion of electromagnetic induction speeded in the air of mobile networks to electric power Radio frequencies (RF) used to charge mobile devices.
The device consists of:
Polarization unit that is a reception antenna with two ends in the form of a copper capillary tubular and connected to the circuits of routing, evaluation and storage of current. Then goes to the DC (routing circuit) and converts the alternate (AC) power from the antenna to the constant DC.
The communication unit
It is an electronic circuit that contains a chip to connect with the communication towers, it is to help to configure dense electromagnetic field near the polarization unit for the purpose of harvesting and converting it into electrical energy.
Super Accumulating Circuit: They are huge capacitors.
Temporary accumulating circuit: It is a current regulator circuit that regulates the charging of mobile devices and electronic devices (Capacitor) and any device that needs an energy source.
Generation of a hurricane for electromagnetic induction through the technology of reverse antennas.
